(19) United States
(12) Patent Application Publication
(10) Pub. No.: US 2015/0319206 A1
(43) Pub. Date: Nov. 5, 2015

(54) SHARING A MEDIA STATION

(71) Applicant: Apple Inc., Cupertino, CA (US)

(72) Inventors: Mehul K. Sanghavi, San Jose, CA (US); Alexandre M. Macedo, Oakland, CA (US); Scott M. Witt, Menlo Park, CA (US)

(73) Assignee: Apple Inc., Cupertino, CA (US)

(21) Appl. No.: 14/267,808

(22) Filed: May 1, 2014

(51) Int. Cl. H04L 29/06; H04L 29/08

(52) U.S. Cl. CPC H04L 65/60; H04L 67/1078

(57) ABSTRACT

Disclosed are systems, methods, and non-transitory computer-readable storage media for sharing a media station. A user can share a media station with one or more other users. The sharing user can transmit a share request to share the media station with receiving users. A share link configured to provide access to the shared media station can then be sent to each receiving user. In some embodiments, the shared media station can be tailored or customized for the receiving user. For example, the shared media station can be tailored based on user preference data for the receiving user. To customize the shared media station, a new version of the shared media station can be generated based on one or more media station seeds that define the media station, as well as the user preference data. The newly generated version of the media station can then be provided to the receiving user.

### TECHNICAL FIELD

The present disclosure relates to media stations and more specifically to sharing a media station.

### BACKGROUND

Online media stations allow uses to stream media items from any computing device with a network connection. For example, users can stream media stations including music, videos, etc. Media station services provide a variety of available media stations that can be accessed by users. In addition to selecting from available media stations, users can often create customized media stations that are generated based on media station seeds selected by the user. A user may wish to share media stations with friends, however current systems are limited in their functionality.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for sharing a media station. In the present technology, a user can share a media station with one or more other users. For example, the sharing user can transmit a share request requesting to share the media station with one or more specified receiving users. A share link configured to provide access to the shared media station can then be sent to each receiving user.

In some embodiments, the shared media station can be tailored or customized for the receiving user. For example, the shared media station can be tailored based on user preference data for the receiving user. To customize the shared media station, a new version of the shared media station can be generated based on one or more media station seeds that define the media station, as well as the user preference data. The newly generated version of the media station can then be provided to the receiving user.

In some embodiments, a limited preview version of the shared media station can be provided to the receiving user. This can allow the receiving user to preview the shared media station without requiring that the shared media station to be added to the receiving user's listing of media stations. The limited preview version of the media station can allow the receiving user to view the media items, artists, genres, etc., included in the media station. The receiving user can then select whether to add the shared media station to their listing of media stations.

In some embodiments, the receiving user can recommend a modification to the shared media station. For example, the receiving user can select one or more additional media station seeds to modify the media station. A modified version of the media station can then be generated for the receiving user and the sharing user based on the original media station seeds, the additional media station seeds and the user preference data of the respective user.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary system embodiment of a computing device;

FIG. 2 illustrates an exemplary method embodiment of sharing a media station

FIG. 3 illustrates an exemplary embodiment of modifying a shared media station;

FIGS. 4A-4H illustrate exemplary possible system embodiments; and

FIGS. 5A and 5B illustrate exemplary possible system embodiments.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for sharing a media station. A user can share a media station with one or more other users. For example, the sharing user can transmit a share request to a media station server requesting to share the media station with one or more specified receiving users. The media station server can send a share link configured to provide access to the shared media station to each receiving user's client device.

In some embodiments, the shared media station can be tailored or customized for the receiving user. For example, the shared media station can be tailored based on user preference data for the receiving user. To customize the shared media station, the media station server can generate a new version of the shared media station based on one or more media station seeds that define the media station, as well as the user preference data. The media station server can then provide the newly generated version of the media station to the receiving users.

In some embodiments, a limited preview version of the shared media station can be provided to the receiving user. This can allow the receiving user to preview the shared media station without requiring that the shared media station to be added to the receiving user's listing of media stations. The limited preview version of the media station can allow the receiving user to view the media items, artists, genres, etc., included in the media station. The receiving user can then select whether to add the shared media station to their listing of media stations.

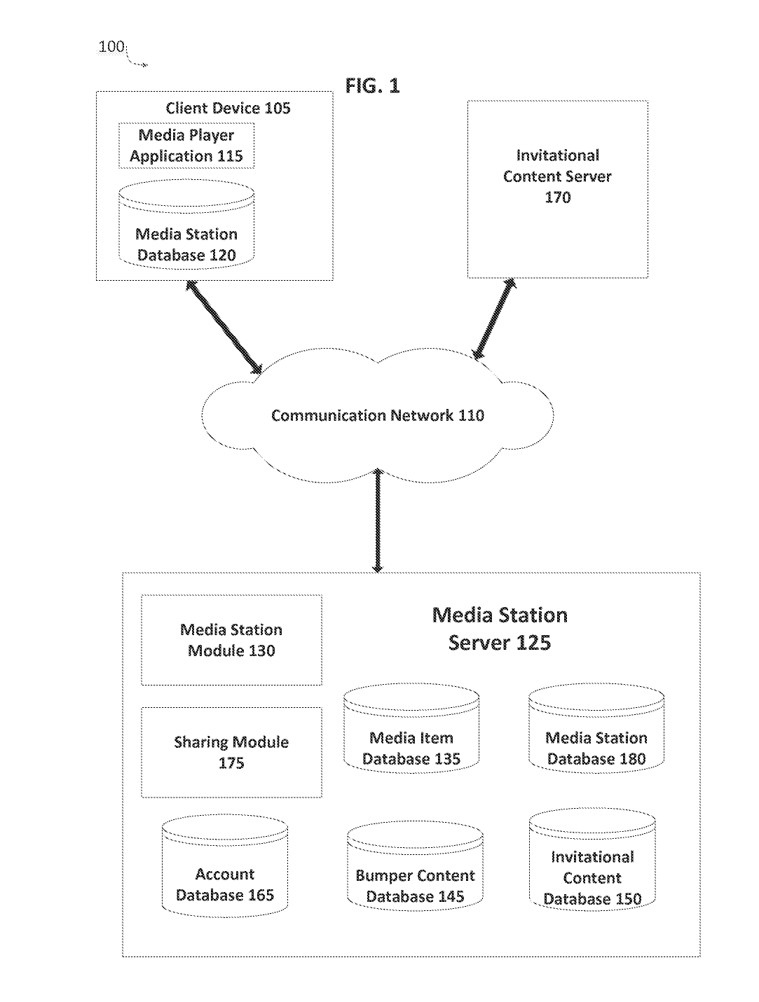

FIG. 1 illustrates an exemplary system configuration 100 in which multiple computing devices can be configured to communicate with each other to create and perform a media station on a client device 105. A media station can be a sequence of media items that can be played, presented, or executed by a media station player application 115 on a client device 105. Some non-limiting examples of media items can include songs, podcasts, television shows, movies, games, audiobooks, educational courses, live concerts, articles, and videos. Other media items are also possible. A media station player 115 can be any application, or any component or portion thereof, capable of media item playback, such as a component of a webpage, a plug-in, a client-side application, etc.

In some embodiments, a media station can be a continuous sequence of media items such that as one media item completes playback a next media item begins. The playback process of a continuous media item stream can repeat until a user takes an action to terminate or temporarily delay the playback, such as quitting the media player application 115, switching to a different media station, pausing playback, or skipping a media item. However, a media station can also be defined to be a finite sequence of media items.

Also, a media station can be homogeneous or heterogeneous. That is, a media station can be designed to playback media items all of the same media type or of different media types. For example, a homogeneous media station can playback only audio media items or only video media items. In another example, a heterogeneous media station can playback a mix of audio media items and video media items. In some embodiments, the various media items can be presented concurrently such that presentation of one media item overlaps with presentation with a different media item.

A media station can also be configured to play or present invitational content, such as advertisements, within the media stream. An invitational content item can include content found in a media item, such as a song or a video, but an invitational content item can also include targeted content and/or content designed to elicit a response from a user. Therefore an invitational content item and a media item can be distinct item types, each of which can be presented in a media station.

In some embodiments, the invitational content can be used as a source of revenue and/or to subsidize a media station so that the media items can be provided to end users free of charge or for a reduced fee. The invitational content can be presented within a media station using a variety of techniques. In some embodiments, invitational content can be presented to a user in a manner that prevents or blocks the playback of a next media item or a next segment of a media item. For example, upon the completion of the playback of a music item, but before beginning playback of a new music item, an invitational content item can be presented in the media stream. Invitational content can also be displayed in conjunction with a media item or media item representation. For example, an invitational content item can be presented in a banner ad displayed with a music album cover or during the playback of a television show.

Further, in some embodiments, the invitational content can include an interactive segment that can be presented concurrently with one or more media items. The interactive segment can be configured such that a user can interact with the invitational content without disrupting playback of media items being presented concurrently. A user can thus interact with various features and views of the interactive segment during the playback of a media item without disrupting the media item. For example, in some embodiments, the interactive segment can be a rich media advertisement that includes various views and screens which a user can navigate through while listening to an audio media item.

A downside to presenting both invitational content and media items that are unrelated, either simultaneously or sequentially, is that a user may equate the media item with the invitational content. For example, a user may think that an invitational content provider endorses a particular media item, or that a media item provider has authorized the use of the media item to promote an offering associated with the invitational content. To decrease the potential for confusion, the media station can also include bumper content, which can be presented concurrently with the interactive invitational content, but just prior to resuming playback of a media item.

A bumper content item can be an intermediary content item that is used to transition from invitational content to a media item, thereby creating user awareness that the media item is not related to an item of invitational content that the user may also be experiencing. For example, a bumper content item can be an audio message such as “now back to the music” that is used to transition between invitational content to an audio media item. Thus a user that is interacting with the interactive segment of an item of invitational content will be made aware that the upcoming media item is not related to the item of invitational content, even though the user is experiencing both concurrently.

To facilitate providing a media station to be performed by a client device 105, multiple computing devices can be connected to a communication network 110 and configured to communicate with each other through use of the communication network 110. The communication network 110 can be any type of network, including a local area network (“LAN”), such as an intranet, a wide area network (“WAN”), such as the internet, or any combination thereof. Further, the communication network 110 can be a public network, a private network, or a combination thereof. The communication network 110 can also be implemented using any type or types of physical media, including wired communication paths and wireless communication paths associated with one or more service providers. Additionally, the communication network 110 can be configured to support the transmission of messages formatted using a variety of protocols.

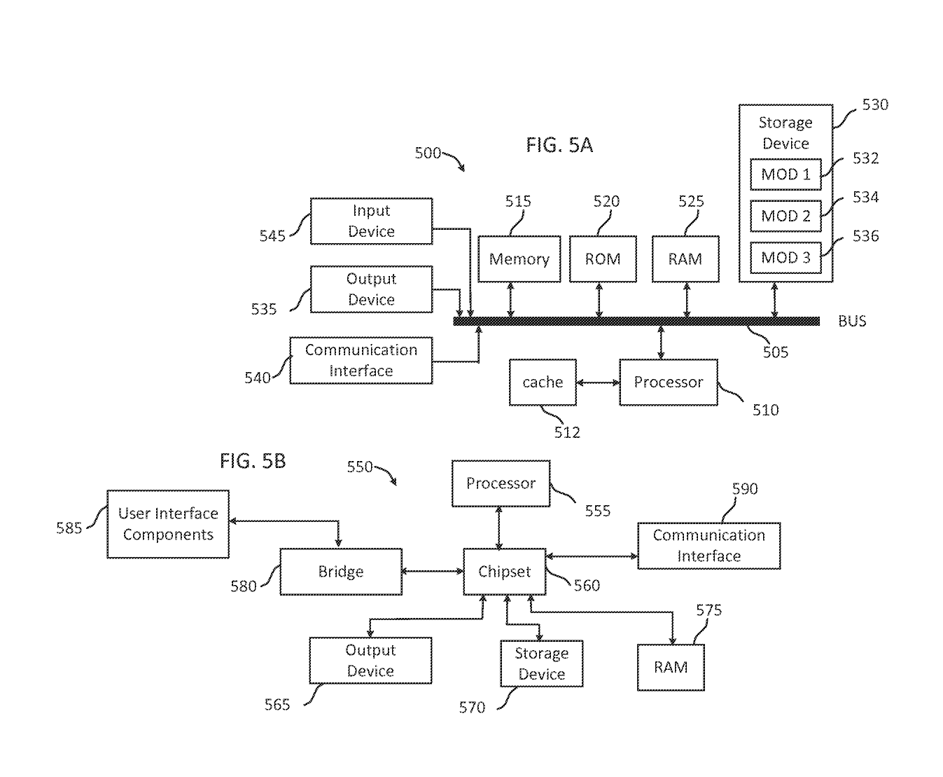

Any of the components in FIG. 1 can be implemented using a computing device. A computing device can be any type of general computing device capable of network communication with other computing devices. For example, the computing device can be a personal computing device such as a desktop or workstation, a business server, or a portable computing device, such as a laptop, smart phone, or tablet personal computer. The computing device can include some or all of the features, components, and peripherals of computing device 500 of FIG. 5.

To facilitate communication with other computing devices, the computing device can also include a communication interface configured to receive a communication, such as a request, data, etc., from another computing device in network communication with the computing device and pass the communication along to an appropriate module running on the computing device. The communication interface can also be configured to send a communication to another computing device in network communication with the computing device.

As illustrated, a client device 105 can be configured to communicate with a media station server 125 to perform a media station on the client device 105. For example, a media player application 115 running on the client device 105 can be configured to communicate with a media station module 130 on the media station server 125 to request, receive and perform a media station. A media station player can be any application capable of media item playback, such as a component of a webpage, a plug-in, a client-side application, etc.

The media station module 130 can be configured to generate a media station to be presented on a client device 105. For example, the media station module 130 can be configured to generate the media station by selecting media items, invitational content items and bumper items to be performed on the client device 105 in a specified order.

In some embodiments, the media station module 130 can be configured to generate a media station based on one or more media station seeds that define the media station. A media station seed can be any type of source data used to select media items, invitational content items and/or bumper content items, for inclusion in a media station. For example, a media station seed can be a genre, author, media item, artist, advertiser, media item characteristic, etc. The media station module 130 can select media items, invitational content items and bumper content items that are similar and/or related to the media station seed. For example, when provided with an artist as a media station seed, the media station module 130 can select media items authored by the seed artist, as well as media items authored by artists that are similar to the seed artists. Likewise, when provided with a song as a media station seed, the media station module 130 can include the seed song in the media station, as well as other songs that are similar to the seed song.

In some embodiments, the media station server 125 can provide one or more predefined media stations. That is, the media station server 125 can have access to media station seeds defining one or more media stations. For example, media station server 125 can include media station database 180 that is configured to maintain a media station index listing the available media stations. The media station index can include the media station seeds that define each listed media station. Each listed media station in the media station index can be identified by a unique media station identifier. Media station module 130 can be configured to communicate with media station database 180 to identify the media station seeds defining a specified media station, which can then be used to generate the media station.

In some embodiments, the media station server 125 can be configured to enable a user to create a custom media station. For example, the media station module 130 can be configured to enable a user to enter one or media station seeds to create a custom media station generated from the provided media station seeds. The media station module 130 can generate the custom media station from the media station seeds received from the user.

The media station server 125 can include a media item database 135, a bumper content database 145 and an invitational content database 150, each configured to store multiple media items, bumper content items, and invitational content items respectively. The media station module 130 can be configured to communicate with the databases to select media items, bumper content items and invitational content to be performed as part of the media station. The selected media items, bumper content items and invitational content items can also include metadata describing the respective item, which can be used to provide data describing the item when presented as part of the media station. For example, the metadata can include artist name, album, author, image, genre, creation date, etc., which can be presented along with the respective item when presented as part of the media station.

Although the media item database 135, bumper content database 145 and the invitational content database 150 are illustrated separately, this is just one possible embodiment and is not meant to be limiting. In some embodiments, the databases can be combined as one database or any other possible combination.

Alternatively, in some embodiments, the multiple databases can be hosted on separate computing devices and the media station module 130 can be configured to communicate with the various computing devices to assemble the media station. For example, in some embodiments, the system can include an invitational content server 170 in network communication with the media station server 125 and the media station module 130 can be configured to communicate with the invitational content server 170 to request invitational content to be included in the media station. In some embodiments, the invitational content server 170 can transmit the invitational content to the media station server 125 where it can be assembled into the media station. In some embodiments, the invitational content server 170 can transmit the invitational content directly to the client device 105.

In some embodiments, the media station module 130 can be configured to generate a media station that is tailored or customized to a particular user based on user preference data of the user. For example, the media station module 130 can be configured to generate a media station from the one or more media station seeds that define the media station as well as user preference data for the user. User preference data can indicate the user's preferences in regards to media items, invitational content items and/or bumper content items, and the generated media station can be tailored according to those preferences. The user preference data can indicate artists, songs, genres, media item characteristics, etc., that a user likes or dislikes, and the media station module 130 can be configured to generate the media station according to the user's likes and dislikes. For example, a media station can be customized to tailored to a user's tastes by including media items, invitational content items, etc., that the user is expected to like, while excluding those that the user is expected to dislike.

The media station server can include an account database 165 configured to store user profile data for user accounts maintained by the media station server 125. For example, users can create an account with the media station server 125 and user profile data gathered regarding the user can be maintained in the user's account in the account database 165. The user profile data can include user preference data for the users associated with the respective user accounts. The media station module 130 can be configured to communicate with the account database 165 to access the user preference data that can then be used to generate a media station customized or tailored to the user.

In some embodiments, a media station server 125 can be configured to enable a user to add media stations to their user account, resulting in the added media station being made available to the user when the user accesses media station 125. The user preference data associated with a user can include data identifying the media stations added to the user's account. For example, the user preference data can include a media station identifier identifying each media station added to the user's account.

In some embodiments, the media station module 130 can be configured to transmit the assembled media station to the client device 105 where it can be performed by the media player application 115. For example, the media station module 130 can be in continuous communication with the media player application 115 to transmit the media station to be performed by the media player application 115.

In some embodiments, the media station module 130 can be configured to transmit the media station to the client device 105 in segments. For example, the media station module 130 can be configured to communicate with the client device 105 to transmit an assembled segment of the media station which can be stored on the client device 105 and performed by the media player application 115. For example, the client device 105 can include a media station database 120 configured to store the received media station and the media player application 115 can be configured to communicate with the media station database 120 to retrieve the stored media station. In this type embodiment, the media station module 130 can be configured to periodically update the client device 105 by transmitting further assembled segments of the media station.

In some embodiments, the media station can be assembled at the client device 105 rather than at the media station server 125. For example, the media station module 130 can be running on the client device 105 and can be configured to request media items, bumper content items and invitational content from the media station server 125, or any other computing device. The received media items, bumper content items and invitational content can be stored in the media station database 120 and the media station module 130 can be configured to communicate with the media station database 120 to retrieve the stored media items, bumper content items and invitational content to assemble the media station. In this type of embodiment, the media station module 130 running on the client device 105 can be configured to periodically request further media items, bumper content items and invitational content be delivered to the client device 105.

In some embodiments, the media station server 125 can be configured to enable a user to share a media station with one or more other users. For example, media station server 125 can include sharing module 175 configured to receive a share request from a client device 105. The share request can request that a specified media station be shared with one or more other users.

The share request can identify the media station to be shared as well as each of the receiving users selected to receive the shared media station. For example, the share request can include a media station identifier that identifies the selected media station. Sharing module 175 can be configured to communicate with the media station database 180 to access the media station based identified by the received media station identifier.

The share request can also include user identifiers that identify the receiving users that are to receive the shared media station. A user identifier can be any type of identifier that identifies a receiving user. For example, a user identifier can be a unique account identifier that identifies a user account associated with the receiving user. The sharing module 175 can be configured to communicate with account database 165 to access the user account identified by a unique account identifier. This can include accessing contact information associated with the user account, such as an e-mail address, phone number, etc. Alternatively, a user identifier can be direct contact information of the receiving user, such as a phone number, e-mail address, etc.

Upon receiving a share request, the sharing module 130 can be configured to identify the media station and receiving users identified by the share request and share the media station with the receiving users. In some embodiments, sharing module 130 can transmit a share link to the receiving users that can be used to access the shared media station. For example, the sharing module 130 can transmit the share link as an e-mail, instant message, text message, etc.

The share link can be configured such that, when selected, the share link communicates with the media station server 125 to request the shared media station. For example, the share link can be embedded with the media station identifier, which can then be returned to the media station server 125 upon selection of the share link. The media station server 125 can identify the media station from the media station identifier and provide the shared media station to the receiving user.

In some embodiments, the media station can be performed directly from the share link. For example, the share link can include executable code enabling performance of the shared media station from within an application such as a messaging application used to transmit the share request. In some embodiments, the shared media station is provided to the user within the media player application 115 on the client device 105. For example, the share link can be configured to, upon selection, cause the client device 105 to execute the media player application to perform the shared media station.

In some embodiments, the shared media station can automatically be added to the receiving user's listing of added media station so that the shared media station will be available to the user whenever the user logs into their account with media station server 125. For example, sharing module 175 can edit the receiving user's user profile data in account database 165 to include the shared media station in the receiving user's listing of added media stations.

In some embodiments, the sharing module 175 can determined if the receiving user already has the shared media station added to their listing of added media stations. For example, the receiving user may have already created a media station from the same seeds as the shared media station and added it to their listing of added media stations. If the shared media station is already included in the receiving user's listing of added media stations, there is no need for the sharing module 175 to add the shared media station. Further, in some embodiments, the sharing module 175 can cause the receiving user's client device to execute the media station application 115 and perform the shared media station.

Alternatively, in some embodiments, the shared media station can be provided to the receiving user without being added to the receiving user's listing of added media stations. If the receiving user likes the shared media station, the receiving user can then select to add the media station to their listing of added media stations.

In some embodiments, the shared media station can be provided to the receiving user in a limited format. For example, the shared media station can be provided to allow a user to preview the various types of media items that are included in the media station, such as the songs, movies, artists, etc., that can presented as part of the media station. In some embodiments, the limited format of the media station can include a subset of the media items included in the shared media station rather than the full version. This can allow a user to quickly preview the media station. Alternatively, in some embodiments, the limited media station can include metadata describing the media items that will be included in the media station. For example, the limited media station can include a listing of the artists, songs, etc. included in the shared media station that can be browsed by the receiving user. Additionally, the limited media station can include images associated with the various artists, songs, etc., that the receiving user can browse through to preview the shared media station.

In some embodiments, the media station server 125 can be configured to provide a receiving user with a customized version of the shared media station that is tailored to the receiving user. For example, the sharing module 175 can request that the media station module 130 generate a version of the shared media station based on the one or more media station seeds that define the shared media station, as well as user preference data of the receiving user. To accomplish this, the sharing module 175 can gather the one or more media station seeds that define the shared media station from the media station index in the media station database 180. The sharing module 175 can also gather user preference data from the receiving user's profile in the account database 165. The sharing module 175 can pass the gathered media station seeds and user preference data to the media station module 130, which can then generate a customized version of the shared media station for the receiving user.

Providing the receiving user with a customized version of the shared media station that is tailored to the receiving user can result in the sharing user and the receiving user being presented with different versions of the same media station, meaning that each version of the media station is generated based on the same one or more media station seeds, while being customized based on the user preference data of the respective user. Customizing the media station based on the user preference data of the user can provide each user with a different version of the shared media station that is best suited for the respective user's tastes. For example, if the receiving user's preference data indicates that the receiving user does not like a specified artist, the shared media station generated for the receiving user can be customized to exclude songs by the specified artist. Likewise, if the receiving user's preference data indicates that the receiving user likes a specified artist that the sharing user dislikes, the version of the shared media station generated for the receiving user can include media items authored by the specified artist, while the version of the shared media station provided to the sharing user can exclude media items authored by the specified artist.

In some embodiments, the media station server 125 can be configured to enable the receiving user to suggest a modification to the shared media station. For example, upon receiving a shared media station, the receiving user can suggest to modify the shared media station by adding one or more further media station seeds to the shared media station. Upon receiving a recommendation from a sharing user, the sharing module 175 can regenerate the media station based on the original one or media station seeds as well as the newly recommended media station seeds received from the receiving user. The newly regenerated media station can then be shared with the receiving user(s) as well as the sharing user, allowing two or more users to remotely generate a media station by suggesting new media station seeds. Further, in some embodiments, each user, the receiving user and the sharing user, can receive a version of the newly generated media station generated based on the respective user's preference data. This process can be repeated between the various users, enabling them to interact to create a customized media station.

In some embodiments, the sharing module 175 can be configured to present the receiving user with suggested recommended media station seeds to further configure the shared media station. For example, the sharing module 175 can identify one or more similar seeds to the seeds that define the shared media station. This similar seeds can be presented to the receiving user, where they can be selected as s suggested modification to the shared media station.

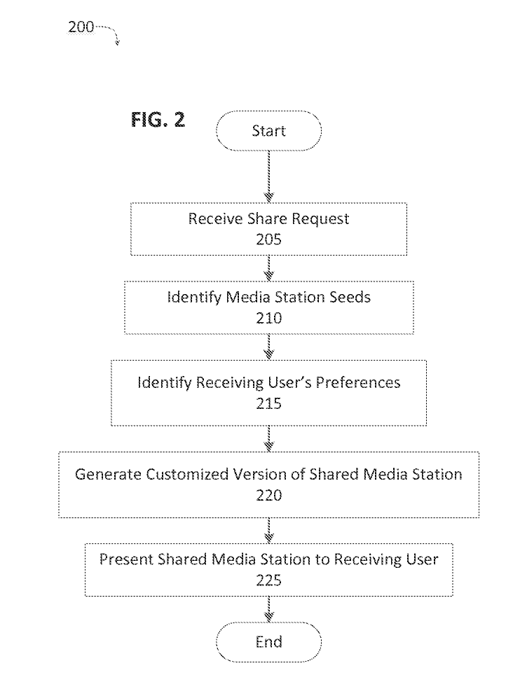

FIG. 2 illustrates a flowchart of steps in an exemplary method 200 for sharing a media station. As shown, the method begins at block 205 where a media station server 125 receives a share request from a sharing user. The share request can request to share a media station with a receiving user.

Upon receiving the share request, the method 200 continues to block 210 where the media station server 125 identifies the media station seeds defining the shared media station. For example, the share request can include a media station identifier identifying the media station, which can be used to identify the media station seeds that define the media station.

The method 200 then continues to block 215 where the media station server 125 gathers user preference data for the receiving user. The share request can include a user identifier identifying the user account of the receiving user and the user preference data can be gathered from the identified user account. The user preference data can indicate the receiving user's preferences in regards to media stations. For example, the user preference data can indicate the receiving user's likes and dislikes with respect to artists, songs, movies, advertisements, products, etc.

The method 200 then continues to block 220 where the media station server 125 generates a customized version of the shared media station for the receiving user based on the one or more media station seeds that define the shared media station as well as the user preference data of the receiving user. The customized version of the shared media station can be tailored to include and exclude media items, invitation content items, etc., based on the media preference data of the receiving user, and thus can be different than the version of the shared media station provided to the sharing user.

Upon generating the customized version of the shared media station, the method 200 continues to block 225 where the media station server 125 presents the generated media station to the receiving user. For example, a share link configured to access the shared media station can be transmitted to the receiving user. The share link can be transmitted in numerous ways, such as in an e-mail, text message, instant message, etc. The method 200 can then end or repeat.

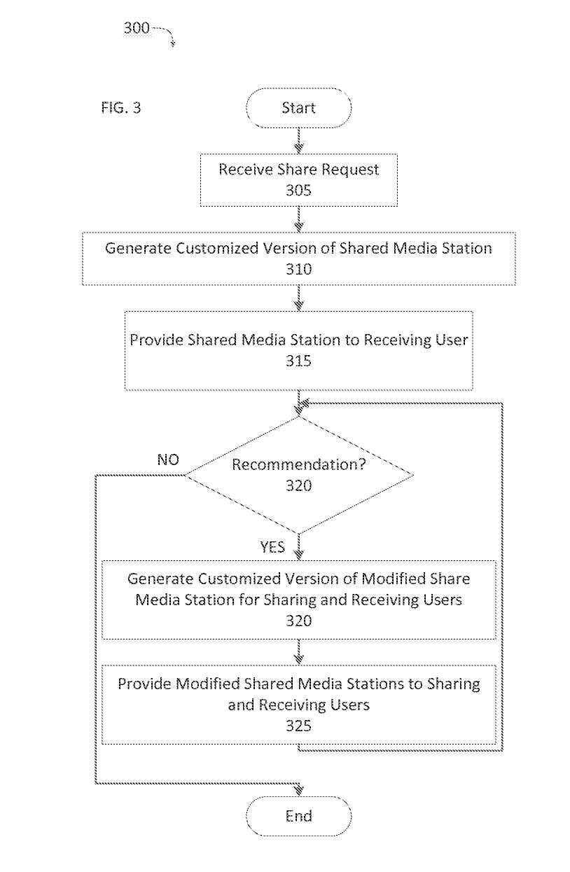

FIG. 3 illustrates a flowchart of steps in an exemplary method 300 for of modifying a shared media station. As shown, the method 300 begins at block 305 where a media station server 125 receives a share request from a sharing user. The share request can request to share a specified media station with a receiving user.

At block 310, the media station server 125 generates a customized version of the shared media station from the media station seeds that define the shared media station, as well as user preference data of the receiving user. The method 300 then continues to block 315 where media station server 125 provides the generated customized version of the shared media station to the receiving user.

The method 300 then continues to block 320 where the media station server 125 determines whether a media station seed recommendation is received. A media station seed recommendation can be a message received from either the sharing or receiving user that recommends that the shared media station be modified to include one or more new media station seeds.

If at block 320 the media station server 125 determines that a media station seed recommendation is received, the method 300 continues to block 325 where the media station server 125 generates a customized version of the modified shared media station for both the sharing user and the receiving user. For example, a customized version of the modified shared media station can be generated for the sharing user based on the one or more media station seeds that define the shared media station, the one or more recommended media station seeds, as well as user preferences of the sharing user. Likewise, a customized version of the modified shared media station can be generated for the receiving user based on the one or more media station seeds that define the shared media station, the one or more recommended media station seeds, as well as user preferences of the receiving user.

At block 330 the media station server 125 provides the appropriate version of the generated modified shared media stations to the sharing user and the receiving user. The method 300 then returns to block 320. If at block 320 the media station server 125 determines that a media station seed recommendation is not received, the method 300 can end or repeat.

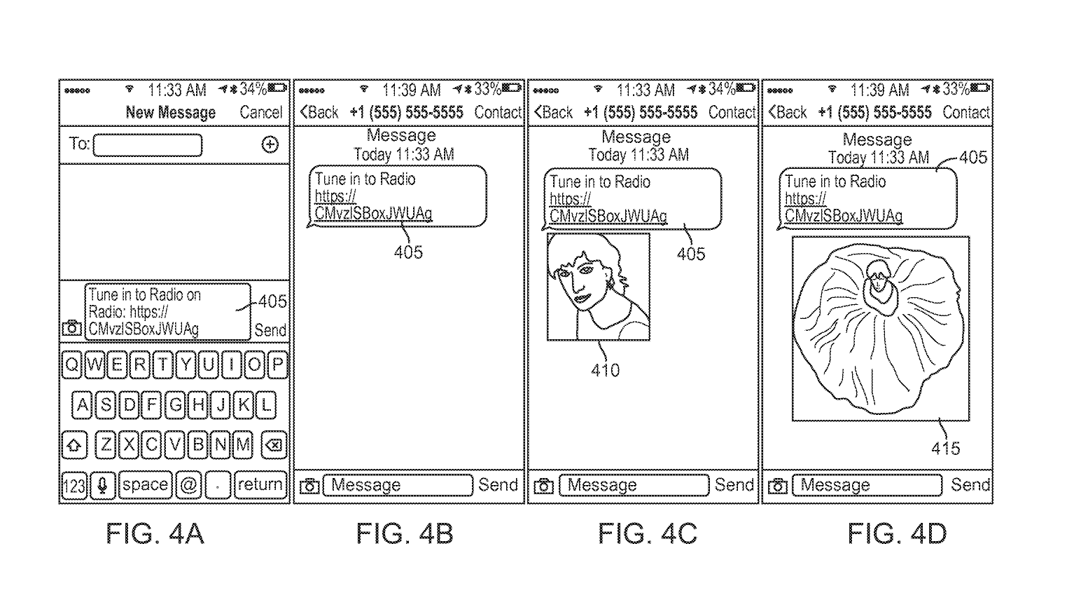

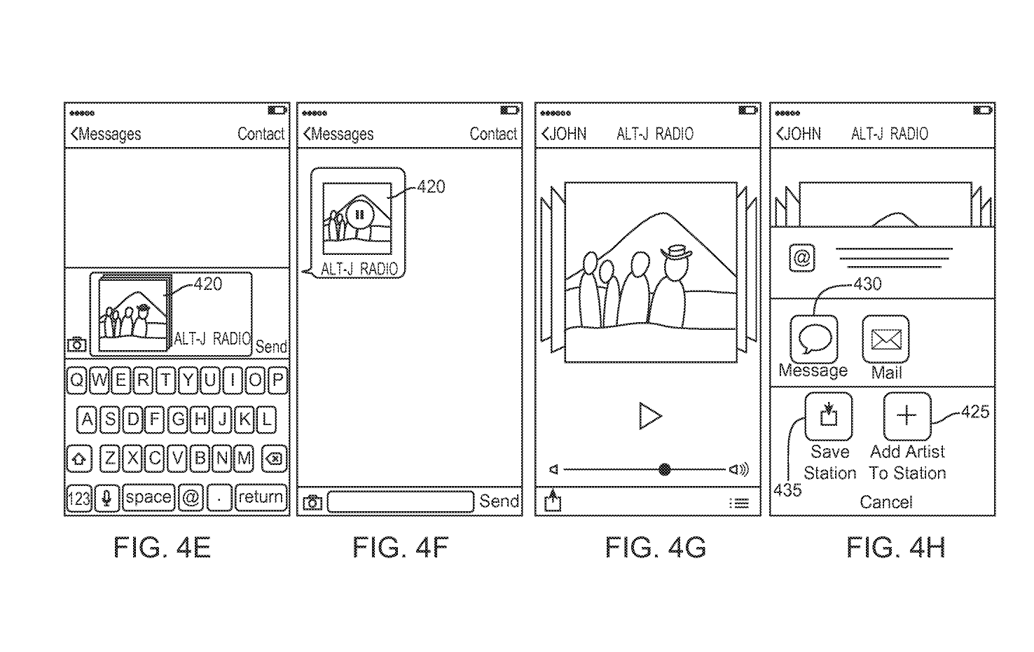

FIGS. 4A-4H illustrate exemplary screenshots of sharing a media station. As shown in FIG. 4A, a sharing user can include a share link 405 to a shared media station in an instant message that can be transmitted to a receiving user. Upon receiving the share link 405, the receiving user can select the share link 405 to access the shared media station. For example, the share link can transmit a message to a media station server requesting the shared media station be provided to the receiving user's client device.

FIG. 4B illustrates an embodiment of the share link 405 received by the receiving user' client device. As shown, the share link 405 is received as an instant message. The receiving user can select the share link 405 to access the shared media station. For example, the share link 405 can be configured to launch a media player application on the client device that can present the shared media station.

FIG. 4C illustrates an embodiment of a share link 405 presented along with metadata describing the shared media station. As shown, the share link 405 is presented along with an image 410 of an artist that is included in the shared media station. In some embodiments, the image 410 can be of a seed artist used to generate the media station. Alternatively, the image 410 can be selected based on the user preference data of the receiving user. For example, the image 410 can be of an artist included in the shared media station that is liked by the receiving user, as determined by the receiving user's preference data.

FIG. 4D illustrates another embodiment of a share link 405 presented along with metadata describing the shared media station. As shown, in this embodiment the image 415 is larger than the image 405 presented in FIG. 4C. Further, the image 415 is of an album rather than an artist. In some embodiments, the image 415 can be of a seed album used to generate the shared media station. Alternatively, in some embodiments, the image 415 can be of an album included in the shared media station that is liked by the receiving user.

In some embodiments, the image 415 can be configured such that a receiving user can scroll through various images describing the shared media station. For example, the receiving user can swipe across the image 415 to bring up another image describing the shared media station. This can allow the receiving user to quickly preview the content of the shared media station.

Further, in some embodiments, the image 415 can be configured to enable a receiving user to perform the shared media station from the instant messaging application. For example, the receiving user can select the image 415, causing media items included in the media station to be performed without requiring use of a media player application. A receiving user can thus listen or watch media items included in the shared media station directly from their messaging application.

In some embodiments, the media items can be presented in a condensed preview format, allowing the receiving user to quickly preview the contents of the media station. For example, a 10 second clip of media items can be played to allow the user to quickly preview multiple media items included in the shared media station.

FIG. 4E illustrates an exemplary screen shot of sharing a media station. As shown, the share link 420 is an image rather than a text link.

FIG. 4F illustrates the share link 420 received by the receiving user's client device. As shown, the share link 420 is presented by a messaging application. Further, as shown, the share link 420 is enabled to perform media stations included in the media station from the messaging application without requiring the execution of a separate media player application. For example, the receiving user can select the share link 420 to perform the shared media station. Alternatively, the share link 420 can be configured to cause a client device to launch a media station application to perform the shared media station.

FIG. 4G illustrates an exemplary screen shot of the shared media station being performed by a media player application. For example, this can be the result of the receiving user selecting the share link, which caused the client device to execute the media player application and perform the shared media station.

FIG. 4H illustrates an exemplary screenshot of a functionality of the media station application. As shown, the media station application can include a message button 430 configured to enable a user to select to share a media station. Further, the media station application can include a save station button 435 configured to add a media station to a user's account, resulting in the added media station being available to the user whenever the user logs into their user account. Finally, the media station application can include an add media station seed button 425 configured to enable a user to suggest an additional media station seed to be added to a media station. For example, the user can select an additional, artist, song, etc., to be added as a media station seed to generate a media station.

FIG. 5A, and FIG. 5B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 5A illustrates a conventional system bus computing system architecture 500 wherein the components of the system are in electrical communication with each other using a bus 505. Exemplary system 500 includes a processing unit (CPU or processor) 510 and a system bus 505 that couples various system components including the system memory 515, such as read only memory (ROM) 520 and random access memory (RAM) 525, to the processor 510. The system 500 can include a cache of high-speed memory connected directly with, in close proximity to, or integrated as part of the processor 510. The system 500 can copy data from the memory 515 and/or the storage device 530 to the cache 512 for quick access by the processor 510. In this way, the cache can provide a performance boost that avoids processor 510 delays while waiting for data. These and other modules can control or be configured to control the processor 510 to perform various actions. Other system memory 515 may be available for use as well. The memory 515 can include multiple different types of memory with different performance characteristics. The processor 510 can include any general purpose processor and a hardware module or software module, such as module 1 532, module 2 534, and module 3 536 stored in storage device 530, configured to control the processor 510 as well as a special-purpose processor where software instructions are incorporated into the actual processor design. The processor 510 may essentially be a completely self-contained computing system, containing multiple cores or processors, a bus, memory controller, cache, etc. A multi-core processor may be symmetric or asymmetric.

To enable user interaction with the computing device 500, an input device 545 can represent any number of input mechanisms, such as a microphone for speech, a touch-sensitive screen for gesture or graphical input, keyboard, mouse, motion input, speech and so forth. An output device 535 can also be one or more of a number of output mechanisms known to those of skill in the art. In some instances, multimodal systems can enable a user to provide multiple types of input to communicate with the computing device 500. The communications interface 540 can generally govern and manage the user input and system output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof.

The storage device 530 can include software modules 532, 534, 536 for controlling the processor 510. Other hardware or software modules are contemplated. The storage device 530 can be connected to the system bus 505. In one aspect, a hardware module that performs a particular function can include the software component stored in a computer-readable medium in connection with the necessary hardware components, such as the processor 510, bus 505, display 535, and so forth, to carry out the function.

FIG. 5B illustrates a computer system 550 having a chipset architecture that can be used in executing the described method and generating and displaying a graphical user interface (GUI). Computer system 550 is an example of computer hardware, software, and firmware that can be used to implement the disclosed technology. System 550 can include a processor 555, representative of any number of physically and/or logically distinct resources capable of executing software, firmware, and hardware configured to perform identified computations. Processor 555 can communicate with a chipset 560 that can control input to and output from processor 555. In this example, chipset 560 outputs information to output 565, such as a display, and can read and write information to storage device 570, which can include magnetic media, and solid state media, for example. Chipset 560 can also read data from and write data to RAM 575. A bridge 580 for interfacing with a variety of user interface components 585 can be provided for interfacing with chipset 560. Such user interface components 585 can include a keyboard, a microphone, touch detection and processing circuitry, a pointing device, such as a mouse, and so on. In general, inputs to system 550 can come from any of a variety of sources, machine generated and/or human generated.

Chipset 560 can also interface with one or more communication interfaces 590 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 555 analyzing data stored in storage 570 or 575. Further, the machine can receive inputs from a user via user interface components 585 and execute appropriate functions, such as browsing functions by interpreting these inputs using processor 555.

It can be appreciated that exemplary systems 500 and 550 can have more than one processor 510 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

We claim:

1. A method comprising:
receiving, by a processor, from a first client device, a share request to share a first media station with a second client device, wherein:
the first media station is defined by at least one media station seed, and
the first client device is presented with a first version of the first media station that was generated based on the at least one media station seed and a first set of user preferences associated with the first client device;
generating, by the processor, a second version of the first media station based on the at least one media station seed and a second set of user preferences associated with the second client device; and
providing, by the processor, the second version of the first media station to the second client device.

2. The method of claim 1, further comprising:
identifying a user account associated with the second client device; and
gathering the second set of user preferences from the user account associated with the second client device.

3. The method of claim 2, further comprising:
receiving, from the second client device, a request to add the second version of the first media station to the second user account; and
adding the second version of the first media station to the second user account, wherein when added to the second user account, the second version of the first media station is made available to client devices authorized to access the second user account.

4. The method of claim 1, further comprising:
receiving, from the second client device, a suggested media station seed;
generating a first version of a second media station based on the at least one media station seed defining the first media station, the suggested media station seed and the first set of user preferences; and
providing the first version of the second media station to the first client device.

5. The method of claim 4, further comprising:
generating a second version of a second media station based on the at least one media station seed defining the first media station, the suggested media station seed and the second set of user preferences; and
providing the second version of the second media station to the second client device.

6. The method of claim 1, wherein generating the second version of the first media station comprises:
determining, from the second set of user preferences, that a first artist should be excluded from the first media station, wherein the second version of the first media station is generated to exclude media items authored by the first artist.

7. The method of claim 1, further comprising:
determining, based on the second set of user preferences, that an artist included in second version of the first media station is liked by a user of the second client device;
selecting an image of the artist included in the second version of the first media station; and
providing, to the second client device, the image of the artist along with the second version of the first media station, wherein the image is presented by the second client device along with the second version of the first media station.

8. A system comprising:
a processor; and
a memory containing instructions that, when executed, cause the processor to:
receive, from a first client device, a share request to share a first media station with a second client device, wherein:
the first media station is defined by at least one media station seed, and
the first client device is presented with a first version of the first media station that was generated based on the at least one media station seed and a first set of user preferences associated with the first client device;
generate a second version of the first media station based on the at least one media station seed and a second set of user preferences associated with the second client device; and
provide the second version of the first media station to the second client device.

9. The system of claim 8, wherein the instructions further cause the processor to:
identify a user account associated with the second client device; and
gather the second set of user preferences from the user account associated with the second client device.

10. The system of claim 9, wherein the instructions further cause the processor to:
receive, from the second client device, a request to add the second version of the first media station to the second user account; and
add the second version of the first media station to the second user account, wherein when added to the second user account, the second version of the first media station is made available to client devices authorized to access the second user account.

11. The system of claim 8, wherein the instructions further cause the processor to:
receiving, from the second client device, a suggested media station seed;
generating a first version of a second media station based on the at least one media station seed defining the first media station, the suggested media station seed and the first set of user preferences; and
provide the first version of the second media station to the first client device.

12. The system of claim 11, wherein the instructions further cause the processor to:
generate a second version of a second media station based on the at least one media station seed defining the first media station, the suggested media station seed and the second set of user preferences; and
provide the second version of the second media station to the second client device.

13. The system of claim 8, wherein generating the second version of the first media station comprises:
determining, from the second set of user preferences, that a first artist should be excluded from the first media station, wherein the second version of the first media station is generated to exclude media items authored by the first artist.

14. The system of claim 8, wherein the instructions further cause the processor to:
determine, based on the second set of user preferences, that an artist included in second version of the first media station is liked by a user of the second client device;
select an image of the artist included in the second version of the first media station; and
provide, to the second client device, the image of the artist along with the second version of the first media station, wherein the image is presented by the second client device along with the second version of the first media station.

15. A non-transitory computer-readable medium containing instructions that, when executed by a computing device, cause the computing device to:
receive, from a first client device, a share request to share a first media station with a second client device, wherein:
the first media station is defined by at least one media station seed, and
the first client device is presented with a first version of the first media station that was generated based on the at least one media station seed and a first set of user preferences associated with the first client device;
generate a second version of the first media station based on the at least one media station seed and a second set of user preferences associated with the second client device; and
provide the second version of the first media station to the second client device.

16. The non-transitory computer-readable medium of claim 15, wherein the instructions further cause the computing device to:
identify a user account associated with the second client device; and
gather the second set of user preferences from the user account associated with the second client device.

17. The non-transitory computer-readable medium of claim 16, wherein the instructions further cause the computing device to:
receive, from the second client device, a request to add the second version of the first media station to the second user account; and
add the second version of the first media station to the second user account, wherein when added to the second user account, the second version of the first media station is made available to client devices authorized to access the second user account.

18. The non-transitory computer-readable medium of claim 15, wherein the instructions further cause the computing device to:
receiving, from the second client device, a suggested media station seed;
generating a first version of a second media station based on the at least one media station seed defining the first media station, the suggested media station seed and the first set of user preferences; and
provide the first version of the second media station to the first client device.

19. The non-transitory computer-readable medium of claim 18, wherein the instructions further cause the computing device to:
generate a second version of a second media station based on the at least one media station seed defining the first media station, the suggested media station seed and the second set of user preferences; and
provide the second version of the second media station to the second client device.

20. The non-transitory computer-readable medium of claim 15, wherein generating the second version of the first media station comprises:
determining, from the second set of user preferences, that a first artist should be excluded from the first media station, wherein the second version of the first media station is generated to exclude media items authored by the first artist.

21. A method comprising:
receiving, from a media station service, by a second client device authorized on a second user account, a second version of a first media station that was shared with the second user account by a first user account, wherein:
the first media station is defined by at least one media station seed,
a first client device authorized on the first user account is presented with a first version of the first media station that was generated based on the at least one media station seed and a first set of user preferences associated with the first user account, and
the second version of the first media station was generated based on the at least one media station seed and a second set of user preferences associated with the second user account; and
presenting, by the second client device, the second version of the first media station.

22. The method of claim 21, further comprising:
transmitting, to the media station server, a first suggested media station seed; and
receiving, from the media station server, a first version of a second media station, wherein the first version of the second media station was generated from the one or media station seeds, the first suggested media station seed and the second set of user preferences.

23. The method of claim 22, wherein, after transmission of the suggested media station seed, the first client device is presented with a second version of the second media station, wherein the second version of the second media station was generated from the one or more media station seeds, the first suggested media station seed and the first set of user preferences.

24. The method of claim 23, further comprising:
receiving, from the media station server, a second version of a third media station, wherein:
the second version of the third media station was generated based on the one or media station seeds, the first suggested media station seed and a second suggested media station seed received by the media station server from the first client device; and
presenting the second version of the third media station.

25. The method of claim 21, further comprising:
transmitting, to the media station server, a request to add the second version of the first media station to the second user account, wherein when added to the second user account, the second version of the first media station is made available to client devices authorized to access the second user account.
